(19) United States
(12) Patent Application Publication
(10) Pub. No.: US 2021/0123592 A1
(43) Pub. Date: Apr. 29, 2021

(54) HIGH MAST LUMINAIRE WITH COOLING CHANNELS

(71) Applicant: CURRENT LIGHTING SOLUTIONS, LLC, East Cleveland, OH (US)

(72) Inventors: David M. Johnson, East Flat Rock, NC (US); Xiaomei Lou, East Cleveland, OH (US); Kenneth A. Lane, East Flat Rock, NC (US)

(21) Appl. No.: 17/080,261

(22) Filed: Oct. 26, 2020

Related U.S. Application Data
(60) Provisional application No. 62/925,745, filed on Oct. 24, 2019.

(51) Int. Cl. F21V 29/71; F21V 23/00; F21V 29/76; F21S 8/08; F21V 7/09; F21V 7/00; F21V 17/12; F21V 31/00

(52) U.S. Cl. CPC F21V 29/71; F21V 23/008; F21V 29/763; F21S 8/086; F21Y 2105/18; F21V 7/0025; F21V 17/12; F21V 31/005; F21V 7/09

(57) ABSTRACT

Pursuant to some embodiments, a high mast luminaire includes a driver housing and a light engine assembly comprising a light engine housing which includes a circumferential wall, the light engine housing comprising an interior space in which a plurality of LED light engines are located, wherein the light engine housing includes a plurality of air flow channels on a radially outer side of the wall, and wherein the air flow channels are separated from the plurality of LED light engines by the circumferential wall.

### RELATED APPLICATIONS

This application is based on, and claims benefit of and priority to, U.S. Provisional Patent Application Ser. No. 62/925,745 filed on Oct. 24, 2019, the contents of which are hereby incorporated in their entirety for all purposes.

### FIELD

The present disclosure relates to high mast luminaires.

### BACKGROUND

A light emitting diode (“LED”) high mast lighting system includes one or more LED high mast luminaires mounted on top of a pole. The LEDs in a high mast luminaire can generate a significant amount of heat. Unless the heat is efficiently dissipated, the life and operational characteristics of the high mast luminaire can be impaired. In some previous high mast luminaires, heat is dissipated using a plurality fins extending upward from a light engine housing (a housing that contains LEDs and optical reflectors) toward a driver housing positioned above the light engine housing. Unfortunately, these approaches increase the weight and increased effective projected areas of the luminaire. These increases can result in higher wind and static loading on the pole. Heavier luminaires are also not beneficial from an installer viewpoint. It would be desirable to provide improved heat dissipation while not having the undesirable weight increase and larger projected area that result from a plurality of fins extending from the from a body of a light engine housing toward the electrical driver housing.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 is a perspective view of a luminaire pursuant to some embodiments.

FIGS. 2A-2C are perspective views of portions of a luminaire pursuant to some embodiments.

FIGS. 3A-3B are views of a bottom side of a light engine housing pursuant to some embodiments.

FIG. 4 is a side section view of a light engine housing pursuant to some embodiments.

FIG. 5 is a view of an arrangement of reflectors for use in a light engine housing pursuant to some embodiments.

FIG. 6 is a side section view of a light engine housing further depicting light emission from the housing pursuant to some embodiments.

FIG. 7 is a partial section view of a driver housing and its connection to a light engine housing pursuant to some embodiments.

FIG. 8 is a view of a bottom side of a light engine housing having an asymmetrical optical configuration pursuant to some embodiments.

FIG. 9A is a partial section view of a bottom side of a light engine housing having an asymmetrical optical configuration pursuant to some embodiments.

FIG. 9B is a view of a bottom side of a light engine housing having an asymmetrical optical configuration pursuant to some embodiments.

FIG. 10 is a partial section view of a light engine housing pursuant to some embodiments.

FIG. 11 is a partial section view of a light engine housing pursuant to a further embodiment.

FIG. 12 is a partial section view of a light engine housing pursuant to a further embodiment.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

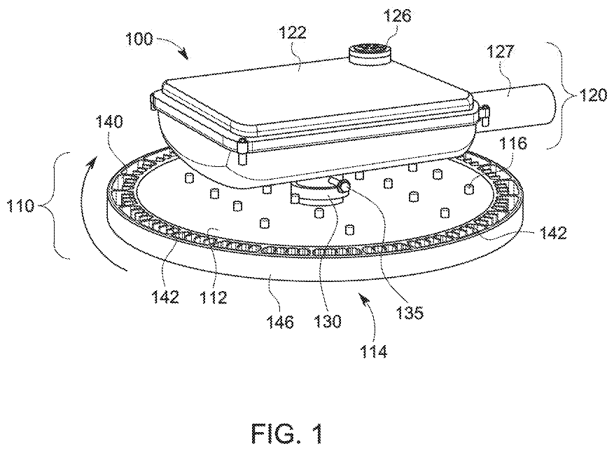

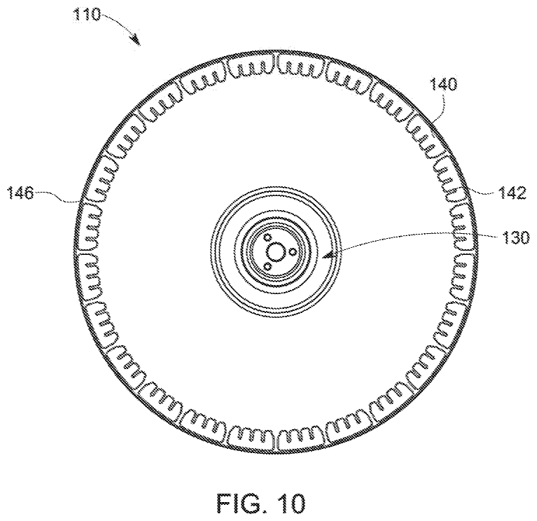

FIG. 1 illustrates a high mast luminaire 100 pursuant to some embodiments. The high mast luminaire 100 generally consists of two principal components—a light engine housing 110 and a driver housing 120. The light engine housing 110 includes a bottom surface 114 from which light can emanate. Further, the light engine housing 110 can include a plurality of cooling channels 140 configured to provide thermal management for dissipating heat from the light sources (not shown) included within the light engine housing 110. In the embodiment depicted in FIG. 1, the cooling channels 140 of the light engine housing 110 are provided with one or more fins 142 partially extending into each cooling channel 140. Further, each cooling channel 140 extends from a main body of the light engine housing 110 to an outer rim 146. The combined surface area of the fins 142, the cooling channels 140 and the outer rim 146 act to dissipate heat from the light sources as described further herein. The cooling channels 140 are configured to extend from a top surface 112 of the light engine housing 110 to a bottom surface 114 of the light engine housing 110 to allow free air flow therethrough. Other configurations of cooling channels will be described further below in conjunction with FIGS. 10-12.

In the embodiment depicted in FIG. 1, the light engine housing 110 has a cross sectional shape approximating a circle, however, those skilled in the art, upon reading the present disclosure, will appreciate that other shapes and may be utilized. The light engine housing 110 typically includes a central stem 130. In some embodiments, the light engine housing 110 may be capable of being rotated around the central stem 130. For example, the light engine housing 110 may be rotated during installation to ensure that the light emanating from the light engine housing 110 is properly directed to a target area (e.g., such as to orient the light along a roadway or the like). In some embodiments, the central stem 130 may comprise a set screw 135 that locks stem 130 and prevents the light engine housing 110 from rotating relative to the driver housing 120. The set screw 135 may also provide friction or pressure against the wall of the driver housing 120 to facilitate mechanical and thermal contact. In some embodiments, the light engine housing 110 may be rotated either counterclockwise or clockwise relative to driver housing 120.

The stem 130 performs the function of coupling the light engine housing 110 to the driver housing 120. In some embodiments, the stem 130 is a cylindrical stem that may insert into a generally cylindrical opening found on the bottom side of the driver housing 120. The stem 130 may be locked into place and secured with a set screw 135 or bolt or other similar fastening element(s).

Pursuant to some embodiments, the light engine housing 110 preferably does not comprise any thermal dissipation structures or fins protruding from the top surface 112 of light engine housing 110 (that is, the surface of the light engine housing 110 that is nearest to the driver housing 120). Instead, the cooling channels 140 function as the primary dissipators of heat. As will be described further below, pursuant to some embodiments, the light emitting assemblies in the light engine housing 110 are positioned such that the heat generating elements are relatively near the cooling channels 140 thereby increasing the ability of the cooling channels 140 to dissipate the heat. In general, pursuant to some embodiments, the top surface 112 of the light engine housing 110 is substantially smooth. In the embodiment depicted in FIG. 1, a plurality of screw bosses 116 are depicted as protruding from the top surface 112. In some embodiments, the screw bosses 116 may be reduced or eliminated.

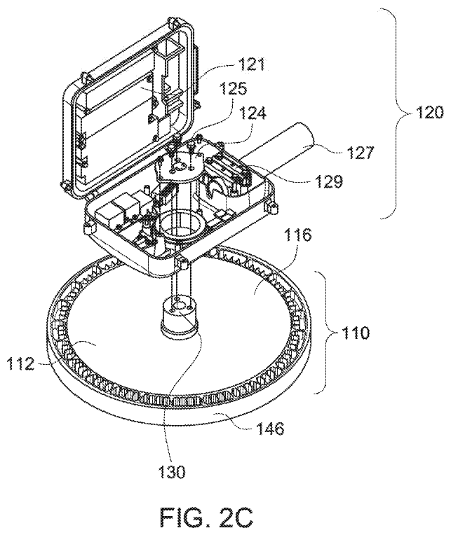

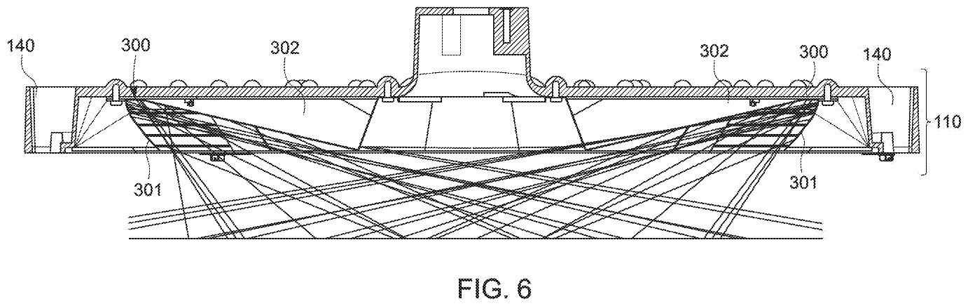

The driver housing 120 can be an electrical enclosure that includes a plurality of components that individually or cooperatively provide electrical and mechanical functionality to the luminaire 100. For example, and not by limitation, the driver housing 120 can include power supplies, signal conditioning circuitry, and metering circuitry for monitoring power consumption in the luminaire 100. In some embodiments, such as where the luminaire 100 uses a symmetrical optical configuration (as described in conjunction with FIGS. 3-7), the driver housing 120 may further include a rotation lock (not shown in FIG. 1 but depicted in FIG. 7) for limiting the rotation of the light engine housing 110. The driver housing 120 may include a driver housing cover 122 that is removably (or, in some embodiments, hingeably) mounted to allow access to the parts included in the driver housing 120. Pursuant to some embodiments, the exterior of the driver housing 120 does not include any fins or any comparable thermal dissipation structures. In other embodiments the driver housing 120 may include one or more fins. Extending from a lateral side of the driver housing 120 may be a mounting arm 127 for mounting or supporting the luminaire 100 driver housing 2 on a pole or in an elevated position generally. The driver housing cover 122 may include an electromechanical receptacle 126 for affixing a photoelectric sensor or other sensing element.

In use, the luminaire 100 of the present disclosure may be employed as plural luminaires on a single pole, where a pole extends into the air with a plurality of arms, each of which may suspend or support the luminaire 100 of the present disclosure. The luminaire 100 may have special applicability to high mast situations, such as street lighting, roadway lighting, lighting of parking lots, or for stadium lighting. It advantageously may be cooled (by air flow) at a perimeter of the light engine housing 110 and may include an optical assembly or configuration that has the shape of a polygon. In typical embodiments, the luminaire 100 does not shine any light upward (that is, it may be referred to as a “zero up-light luminaire”). This is in part due to the fact that, in some embodiments, there are no light sources that exist inside the cooling channels 140, thus preventing “up” light. In a typical embodiment, a flat lens covering may be used (e.g., shown as lens 311 in FIG. 3B).

Some novel aspects of the invention may include the use of a light engine housing 110 that contains channels 140 or vents existing proximate to the periphery of a housing for the light engine. The walls of the light engine housing define an inner space enclosing a plurality of LED light engines. The light engine housing 110 includes through holes, or vents, or channels (hereinafter, merely “channels”), for the passage of air to cool the light engine housing 110 when it is heated by the operation of the LED light engines supported in the inner space of the housing 110.

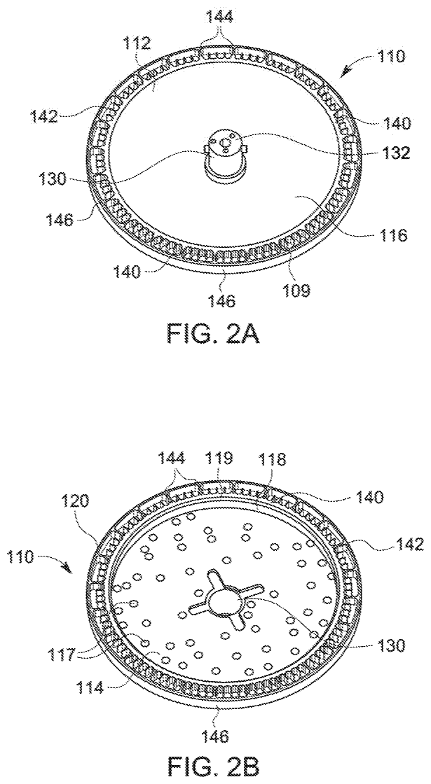

At least some of the cooling channels 140 may allow for the passage of air flow through from one channel end to another channel end, without this air flow contacting a light engine. This may be enabled by the channels 140 being separated from the light engines by at least one wall (e.g., such as the wall 118 shown in FIG. 2B and elsewhere herein). To promote the cooling of the plurality of light engines, the plurality of light engines may be located proximate a circumferential perimeter of the light engine housing 110, so that indirect heat exchange through a wall to the air flow may be facilitated. One advantage for the light engines not being placed inside of cooling channels is that up-light is avoided. Another advantage is that unfiltered outdoor air with contaminates will not come into contact with the LEDs or the optical reflective surfaces of the LED light engines.

As used herein, the term “LED light engine” typically will refer to the combination of circuit board(s) (or other support), and plurality of light emitting diodes mounted on the circuit board(s) or other support. In some embodiments, it may also include any associated reflectors, housing and lens (the “optics”). The light engine housing 110 may house a number of LED light engines.

The light engine housing 110 may be metallic, at least in part, and may be cast. In some aspects, the light engine housing 110 may be capable of being rotated or adjusted about an axis. Typically, the light engine housing 110 may be capable of being selectively rotated on an axis in order to throw the light distribution emanating from the LED light engines in a desired direction. The light engine housing 110 may include an arrangement of LEDs and reflectors that form an axially symmetric light distribution or may form an asymmetric light distribution. The light engine may comprise an arrangement of wedge shaped reflectors that together provide an appearance of a regular polygon (such as an octagon). The light engine housing 110 may incorporate in its interior an array of light emitting diodes that are adjacent to a perimeter of the housing 110. In certain embodiments, the LEDs are enclosed within the light engine housing 110, and the housing comprises channels 140 or vents through which air may flow, but the flow of air passing through the channels 140 does not contact the light emitting diodes. This indicates that the heat exchange relationship between the light engine and the cooling channels is generally an indirect heat exchange.

In some embodiments, the light engines of a luminaire 100 provide, in combination with a reflector assembly, an axially symmetrical light distribution downward from the luminaire 100. In other embodiments, the light in combination with a reflector assembly, provide a non-axially symmetrical light distribution downward from the luminaire, such as a light distribution for lighting roadways. In some embodiments, there are a plurality of reflector assemblies which are arranged in the shape of regular polygon. Such features will become apparent to those skilled in the art upon reading the following disclosure.

Referring now to FIG. 2A, a top view of a light engine housing 110 is shown depicting the top surface 112 of a light engine housing 110 pursuant to some embodiments. The top surface 112 of the light engine housing 110 may comprise a centrally located stem 130 which may be generally cylindrical. A top surface 132 of stem 130 may have a generally flat shape with a circular cross-section and may comprise holes for attachment of fastening elements or screws to a driver housing (not shown in FIG. 2A). The stem 130 may also include passageways or tunnels for passage of wiring (not shown). As discussed above, pursuant to some embodiments, the light engine housing 110 may contain a plurality of cooling channels 140 generally arranged in an annular configuration at a periphery or perimeter of light engine housing 110. These cooling channels 140 may be defined by radial walls 144 that extend from a main body of the light engine housing 110 to an outer rim 146. One or more of the cooling channels 140 may include one or more fins 142 that extend from the main body of the light engine housing 110 to an interior of the cooling channel 140. The cooling channels 140 permit air to flow through and remove heat from the surfaces. In some preferred embodiments, the light engine housing 110 may be formed from material with high thermal conductivity such as cast aluminum to facilitate the conduction of heat from light engines contained within the light engine housing 110 to the cooling channels 140.

Referring now to FIG. 2B, a bottom surface 114 of a light engine housing 110 is shown. The bottom surface 114 transitions to the stem 130 which generally provides a hollow cylindrical recess to facilitate the passage of wiring from electronic drivers in the driver housing (not shown in FIG. 2B) to circuit boards upon which light emitting components (such as light emitting diodes or LEDs) are mounted (not shown in FIG. 2B). The bottom surface 114 of the light engine housing 110 may also include a number of mounting holes 117 for mounting printed circuit boards and assemblies and optical parts (not shown in FIG. 2B). A wall 118 extends around a perimeter of the light engine housing 110 (on the inside of the cooling channels 140). The wall 118 defines a interior space of the light engine housing 110 in which light engines and other components may be placed. A mounting ledge 119 may extend around an interior surface of the wall 118. The mounting ledge 119 may be used to receive and hold a glass lens covering (not shown in FIG. 2B) to protect the light engines and other components within the light engine housing 110 from the outdoor environment.

Referring now to FIG. 2C, a top view of the light engine housing 110 is shown with an opened view of the driver housing 120. The driver housing 120 has an interior that is exposed when the top of the driver housing 120 is opened. As shown, the interior may contain one or more electronic drivers 121 for driving one or more lighting engines (not shown in FIG. 2C). In some embodiments, the driver housing 120 may open in a clamshell fashion with the electronic drivers 121 located in the upper portion of the clamshell; however, other configurations are also possible. The driver housing 120 may further include or house one or more clamps or fixtures 129 for receiving and/or holding a pipe or mounting arm 127. The pipe or mounting arm 127 may extend from a lateral side of the driver housing 120 and may be used to mount the luminaire 100 as discussed above.

The driver housing 120 may also include a plate 124 for attaching the driver housing 120 to the central stem 130. The plate 124 may prevent or facilitate rotation of the stem 130, and in turn prevent or facilitate rotation of light engine housing 110. The plate 124 may be a flat plate shaped and configured to lock the light engine housing 110 from rotating and to hold the light engine housing 110 axially in place. Additionally, a set screw 125 may tighten against the stem 130 to ensure a tight mechanical connection between the driver housing 120 and the light engine housing 110. In some embodiments, the plate 124 and or set screw 125 may facilitate the rotation of the light engine housing 110 to any angle up to about 370 degrees in which a mechanism can be employed to prevent excessive rotation beyond 370 degrees as shown in commonly assigned U.S. Pat. No. 10,247,396, the contents of which are hereby incorporated by reference in their entirety for all purposes).

Further details of portions of the interior of the driver housing 120 may be seen by reference to FIG. 7 which is a partial view of the driver housing 120 in an open position. The plate 124 and the set screws 125 are shown in further detail as well as the attachment of the plate 124 to the top surface of the central stem 130. As shown, when the one or more set screws 125 are loosened, the light engine housing 110 may be free to rotate in relation to the driver housing 120 allowing the lighting to be positioned. When the set screws 125 are tightened, rotation is prevented, fixing the position of the light. Pursuant to some embodiments, when symmetrical light engines are used, the rotation of the light engine housing 110 may not be needed, and rotation may be prevented altogether.

In some embodiments, the light engine housing 110 is rotatable about an axis to allow the luminaire to be aimed. The rotation is generally performed in order to aim the luminaire at a desired target area; once the desired target area is illuminated or caused to be illuminated, then the light engine housing 110 is typically locked into place to keep it focused on the target area.

Pursuant to some embodiments, the light emitting components of the luminaire 100 are a number of light emitting diodes (“LEDs”) positioned near the vicinity of or proximal to the periphery of the light engine housing 110 (near the cooling channels 140). Further, pursuant to some embodiments, to achieve a circular optics pattern and create a roundish light beam pattern, embodiments use a number of reflectors as will be described by first referring to FIG. 3A which is an exploded view of a bottom side of a light engine housing 110. Seated within a space defined by the wall 118 of the light engine housing 110 are a number of circuit board assemblies 300. A reflector assembly (shown as parabolic reflector section 301 and wedge shaped section 302) is affixed to the circuit board assembly 300 and to the bottom surface 114 of the light engine housing 110.

The reflector assembly may comprise a parabolic reflector section 301 and wedge shaped reflector section 302. Parabolic reflector section 301 and wedge shaped reflector section 302 may be separate pieces that are screwed or fixed together as shown or may be integral to each other. LEDs may be mounted to, or otherwise in electrical communication with, the circuit board assembly 300. In some embodiments, the plurality of light engines enclosed within the light engine housing 110 are arrayed in the vicinity or proximal to a periphery of the light engine housing 110 with few or no LED light sources close to the center region of the interior of the plate shaped light engine housing 110.

One reason for avoiding the provision of LED light engines at a location distal from the perimeter is to minimize the temperature rise from the cooling channels 140 to the LEDs. The cooling channels 140 would be too far away from such centrally located light engines. One advantage for employing cooling vents arrayed through the periphery of the light engine housing 110 (in contrast to the provision of fins on an exterior surface of light engine housing 110, for example), is that there would be reduced optical weight and effective projected areas (“EPA”) of the light engine.

FIG. 3B shows a bottom view of light engine housing 110 with an emphasis on how the light engines and reflectors are seated within light engine housing 110. FIG. 3B depicts a plurality of parabolic reflector sections 301 and wedge-shaped reflector sections 302 that have been arrayed circumferentially inside light engine housing 110. The array of reflective elements 301, 302 may form or give the appearance of a regular polygon, such as an octagon. Generally, the LED light engines and reflective assemblies 301, 302 may be isolated from the environment by a transparent or translucent glass piece 311. Glass piece 311 may be a lens that aids in throwing or distributing light or may be formed of clear glass. It may also be constructed of other transparent or translucent substances such as polycarbonate or polyacrylate or other transparent plastics. Glass piece 311 may be sealed to a bottom of light engine housing 110 by first being seated on a ledge that is at a circumferential periphery of light engine housing 110 and then sealed with a gasket. Note that glass piece 311 preferably does not impede or cover the airflow passing through the cooling channels 140.

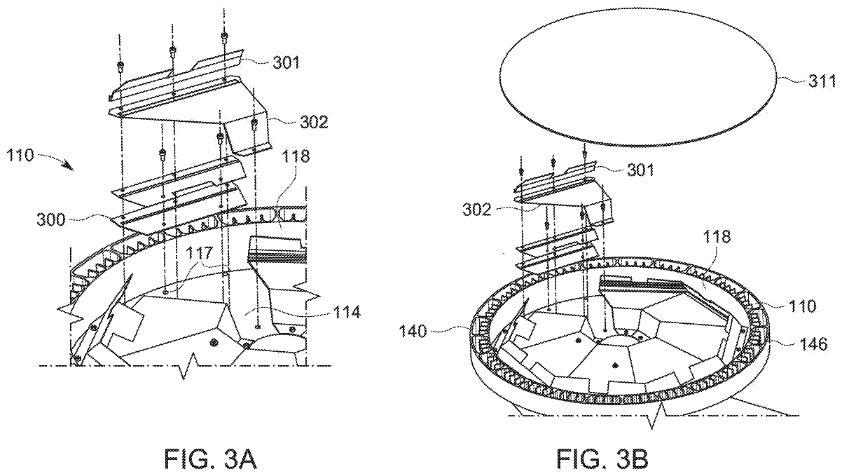

FIG. 4 depicts a side, section view of the light engine housing 110. The positions at which sections of the reflector assembly are placed can be seen in this view. Parabolic section 301 and the wedge shape section 302 are shown positioned about the center (where the central stem 130 enters the light engine housing 110). As will be shown further below, there are a plurality of such parabolic and wedge shaped sections 301, 302 that preferably can provide an axially symmetric distribution of light from LED light engines. The relevant axis is shown geometrically by the line connecting point A to point A′ through the central stem 130. The side view of light engine housing 110 also shows that the reflector assembly is located within a space defined by walls 118. A ledge 119 is formed in the walls 118 to allow glass 311 to seat thereon. The cooling channels 140 are located on an outer periphery of the light engine housing 110 (and as will be discussed, proximate the heat generating lighting elements).

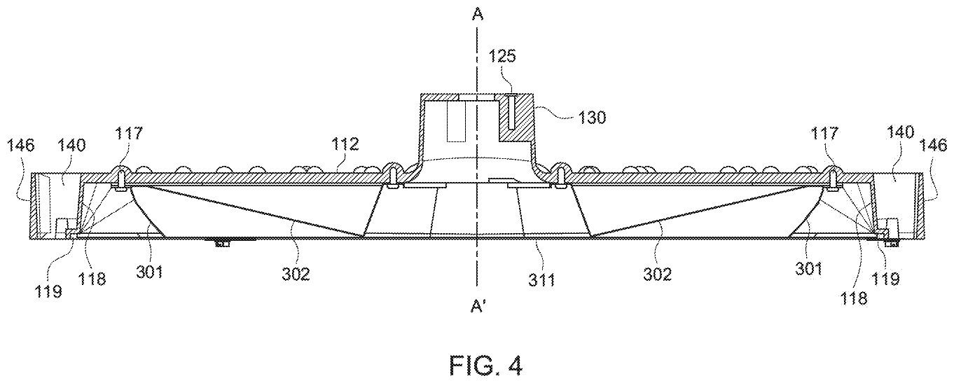

FIG. 5 depicts an embodiment of a light engine housing 110 in which eight sections of reflectors (each having a parabolic section 301, a wedge shape section 302 and LEDs 300) have been combined to create an axial symmetric optical pattern. Generally, the LED light engines 300 are mounted to a perimeter of the interior of the light engine housing 110 as discussed elsewhere herein. The reflector assemblies can be aimed inwards to that light rays from different sections can share space and/or intersect when being reflected traveling outside the luminaire 100. Placing the LED light engines 300 close to the perimeter facilitates dissipation of heat into the cooling channels (not shown in FIG. 5). In some embodiments, cutouts 304 may be created in the section located proximate the LED to allow some downward light from the LED to be emitted.

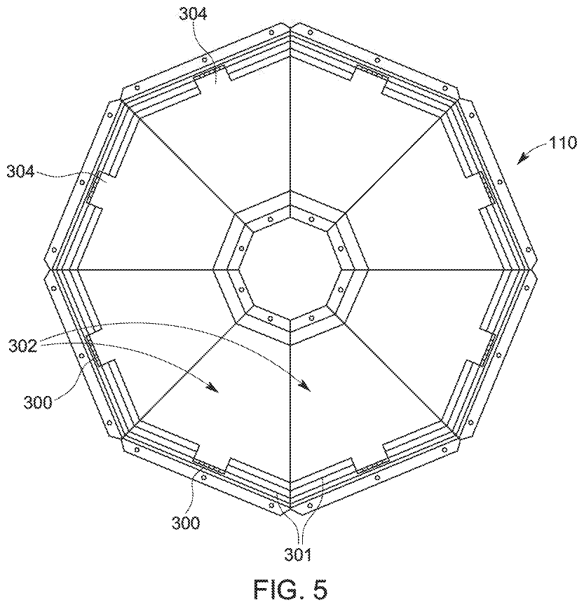

FIG. 6 is another side cutaway view of the light engine housing 110 including parabolic reflector sections 301 and wedge shaped reflector sections 302. The purpose of FIG. 6 is to depict light being emitted by LED light engines 300. As shown, the light emitted from the LED light engines 300 is reflected by reflector sections 301, 302 such that it passes out from the bottom of light engine housing 110. Further, light from the LED light engines 300 may be reflected from parabolic reflector section 301 and passed out of the light engine housing 110 through its bottom, without having been further reflected from wedge shaped section 302. In either case, there is no light directly to the nadir zone and essentially no light emitted directly from the LED light engines 300 without having been reflected from one or more of the reflective sections within the light engine housing 110. In an alternative embodiment, there may be at least some light emitted from the bottom of the light engine housing 110 that is emitted from the LED light engines 300 without having been reflected. In some embodiments where the reflectors are configured to provide an axially symmetric light distribution, such symmetrical distribution may be as wide as 30 to 100 meters in diameter.

The construction of the above-described reflector may be independent from its use within a light engine housing 110 that has peripheral cooling channels 140 located at a circumferential edge. That is, the segmented reflector can be used in other environments. Additionally, it is possible to dispense with the capability to rotate the light engine housing 110, especially in cases where the reflector assembly supplies an axially symmetrical light distribution.

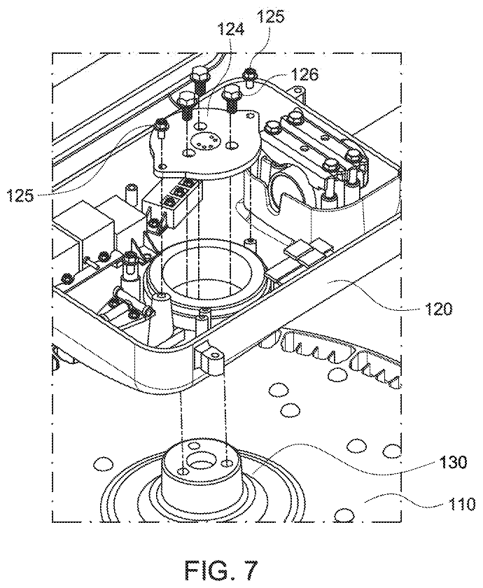

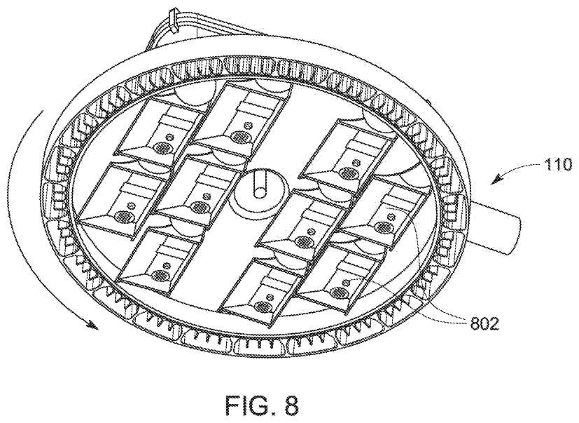

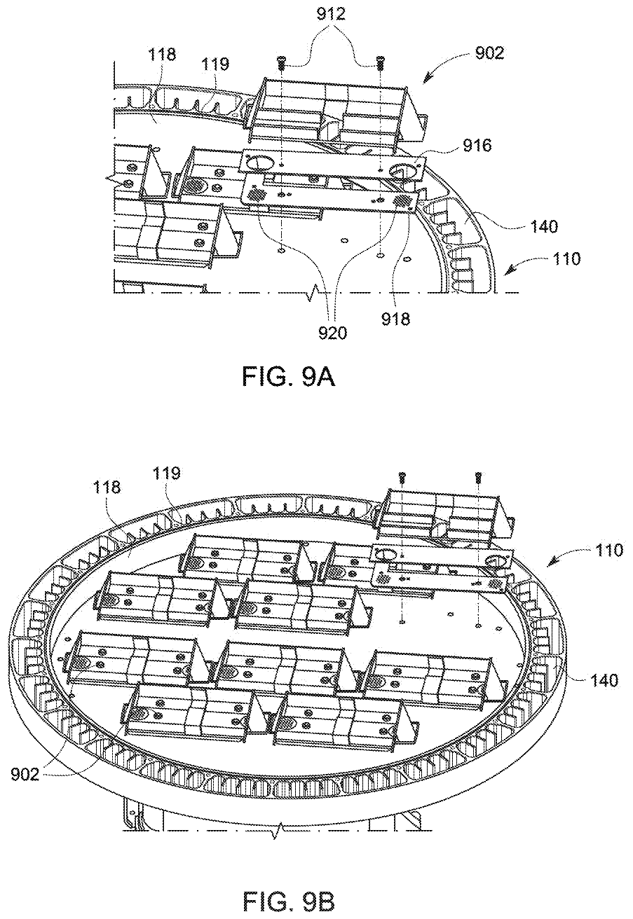

Referring now to FIG. 8, in another aspect, the light engine housing 110 may comprise a plurality of LED light engines 802 that are not arrayed in a symmetrical fashion, but rather may be distributed such that a non-axially symmetric light distribution is formed. For example, light engines 802 may be arrayed on an underside of light engine housing 110 with or without reflective elements. These light engines 802 may be distributed on the underside of light engine housing 110 so as to enable a non-axially symmetric light distribution. A rectilinear light distribution may be favored for applications of lighting roadways up and down a road. In any event, the plurality of light engines in such an asymmetric optical configuration may be protected by a glass lens or glass cover (similar to that shown, for example, in FIG. 3B). Referring now to FIG. 9A, a partial exploded view of an LED light engine 902 is shown. In FIG. 9B, a further view of an illustrative non-axially symmetric arrangement of LED light engines 902 is shown.

In some embodiments, a light engine housing 110 may comprise plural sets of optical assemblies, with one set giving an elongated (e.g., rectilinear) light distribution and another set giving a second elongated light distribution that may not be overlapping with the first. This can be useful for lighting multiple lanes of a highway or roadway, or for lighting different roads.

While some embodiments have been described in which cooling channels are provided proximate to the periphery of a light engine housing and which include a plurality of fins therein, other configurations provide desirable heat dissipation. Referring now to FIG. 10, a top view of light engine housing 110 is shown in which the light engine housing 110 has a plurality of cooling channels 140 around a periphery of the light engine housing 110. As shown, each of the cooling channels 140 extend between a body of the light engine housing 110 and an outer rim 146, and each cooling channel 140 has one or more fins 142 protruding into the cooling channel 140. This arrangement provides a number of desirable benefits, including efficient heat dissipation from the light sources as well as a lowered profile of the luminaire 100 (as compared to luminaires in which one or more heat sinks or fins protrude from a top surface of the light engine housing 110 or from surfaces of the driver housing 120). A lowered profile reduces the effective projected area (“EPA”) of the luminaire 100 thereby reducing the effect of wind force on the luminaire 100.

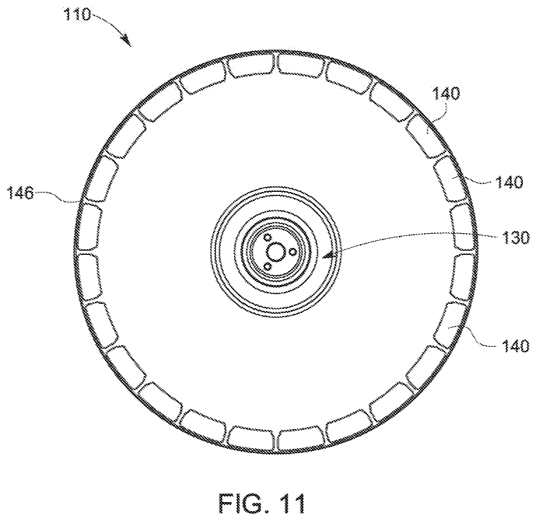

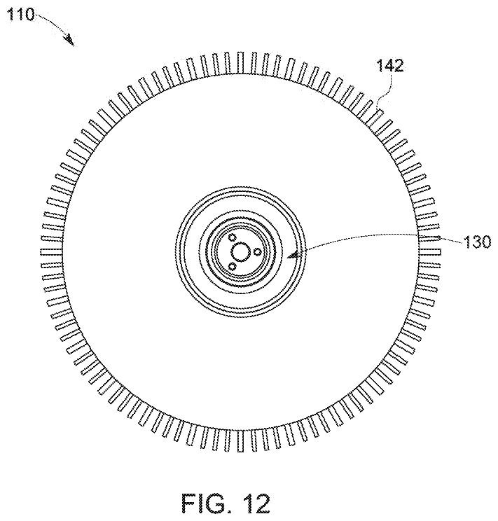

Other configurations of cooling channels may be provided which achieve similarly desirable results. For example, referring now to FIG. 11, a top view of a further embodiment of a light engine housing 110 is shown in which the cooling channels 140 do not include fins protruding into the interior of the cooling channels 140. Such a configuration may provide a reduced heat dissipation surface area but may be manufactured at a reduced cost. As another example, referring now to FIG. 12, a top view of a further example embodiment of a light engine housing 110 is shown in which the cooling channels 140 do not extend to an outer rim. Instead, the cooling channels 140 (and, optionally, one or more fins 142 within those channels 140) are the primary heat dissipation surfaces. Again, such a configuration may provide a reduced heat dissipation surface area but may be manufactured at a reduced cost in comparison to the embodiment depicted in FIG. 10.

The exemplary embodiments shown in FIG. 1, and successive figures, are not intended to be a depiction of exactly how the luminaire 100 will appear in use. A greater or lesser number of cooling channels 140 may be used, and or there may be other surface features or functionalities on a surface of the light engine housing 110 or driver housing. More than one receptacle for sensor (e.g., photosensor) may be present on the driver housing 120, or no sensor receptacle may be present. It is also possible that sensor receptacles may be present on a surface of the light engine housing 110.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

We claim:

1. A high mast luminaire comprising:
a driver housing; and
a light engine housing coupled to the driver housing and including a wall extending around an outer circumference of the light engine housing, the wall defining an interior space in which a plurality of LED light engines are located, the light engine housing further comprising a plurality of air flow channels on an outer side of the wall such that the plurality of air flow channels are separated from the plurality of LED light engines by the wall.

2. The luminaire of claim 1, wherein the air flow channels extend from the wall to an outer rim.

3. The luminaire of claim 1, wherein at least one of the air flow channels includes at least a first fin protruding into the air flow channel.

4. The luminaire of claim 2, wherein at least one of the air flow channels includes at least a first fin protruding into the air flow channel radially from the wall.

5. The luminaire of claim 1, further including a plurality of reflector assemblies, each reflector assembly adjacent to one or more LEDs.

6. The luminaire of claim 5, wherein each of the reflector assemblies comprise a wedge section and a parabolic section, and the reflector assemblies are configured in an arrangement of a polygon.

7. The luminaire of claim 5, wherein each of the reflector assemblies is mounted to at least one of a circuit board assembly and the light engine housing.

8. The luminaire of claim 1, wherein the plurality of LED light engines are located within an interior space proximate to a radially interior side of the wall.

9. The luminaire of claim 8, wherein a majority of LED light engines in the luminaire are located proximate to the radially interior side of the wall.

10. The luminaire of claim 1, wherein the LED light engines are arrayed to form edges of a virtual polygon inside the light engine housing.

11. The luminaire of claim 5, wherein each reflector assembly includes at least one parabolic section and at least one wedge shaped part.

12. The luminaire of claim 11, wherein the parabolic section includes an aperture to allow some direct LED light in downward directions.

13. The luminaire of claim 5, wherein the plurality of reflector assemblies receive light from the LED light engines and reflect the received light such that at least some reflected light rays intersect within the interior space of the housing.

14. The luminaire of claim 1, wherein air flowing through the plurality of air flow channels substantially does not enter the light engine housing and is substantially isolated from the light engines.

15. The luminaire of claim 1, wherein the light engine housing includes a generally hollow stem segment which connects the light engine housing to the driver housing to permit wiring to connect the light engine housing to one or more LED driver circuits in the driver housing.

16. The luminaire of claim 15, further comprising a locking device to permit selective rotation and/or inhibit unwanted rotation of the light engine housing relative to the driver housing.

17. The luminaire of claim 16, wherein the locking device comprises a locking set screw or pin which locks the side of the stem segment against the driver housing to secure one of mechanical and thermal contact of the stem segment to the driver housing.

18. The luminaire of claim 1, wherein the interior space of the light engine housing is sealed to prevent water and dust from the outdoor environment from entering interior space.

19. A light engine housing, comprising:
a body;
a wall extending around an outer perimeter of the body, the wall and the body defining an interior space in which a plurality of LED light engines are positioned; and
a plurality of air flow channels located on an outer side of the wall such that the plurality of air flow channels are separated from the plurality of LED light engines by the wall.

20. The light engine housing of claim 19 wherein the plurality of air flow channels extend from the wall to an outer rim.
